(19) United States
(12) Patent Application Publication
(10) Pub. No.: US 2014/0064270 A1
(43) Pub. Date: Mar. 6, 2014

(54) Using Fabric Port-Channels to Scale IP Connectivity to Hosts in Directly Connected Subnets in Massive Scale Data Centers

(71) Applicants: Shyam Kapadia, Santa Clara, CA (US); Bhushan Mangesh Kanekar, Saratoga, CA (US); Nilesh Shah, Fremont, CA (US)

(72) Inventors: Shyam Kapadia, Santa Clara, CA (US); Bhushan Mangesh Kanekar, Saratoga, CA (US); Nilesh Shah, Fremont, CA (US)

(73) Assignee: CISCO TECHNOLOGY, INC., San Jose, CA (US)

(21) Appl. No.: 13/599,446

(22) Filed: Aug. 30, 2012

(51) Int. Cl. H04L 12/56

(52) U.S. Cl. 370/389

(57) ABSTRACT

Systems and methods are provided for using fabric port-channels for Switched Virtual Interfaces (SVIs) to scale IP connectivity for hosts in directly connected subnets in massive scale data centers. By representing SVIs by internal fabric port-channels, ToRs hosting the SVI can share routed traffic directed toward hosts within the associated vlan in a load-balanced manner without frequent updates to the FIB/Adjacency tables.

### BACKGROUND

Massive scale data centers may be expected to comprise a large number of servers, both physical and virtual. Server-to-server traffic (east-west) is expected to dominate the traffic from the internet (north-south). Typically, the servers are organized into a set of PODs. The interface toward a POD may be referred to as a ToR (Top-Of-Rack) switch. The ToRs themselves may then be interconnected hierarchically via a switch-fabric so that any server should be able to communicate with any other server. Every server, physical or virtual, is associated with a unique IP address (/32 address) and a unique MAC address. Typical configurations may involve the servers being placed in virtual lans (VLANs) so that servers within the same vlan can communicate via

L2/bridging/switching and servers in different vlans communicate through routing via Switched-Virtual-Interfaces (SVIs) also called as Integrated Routing and Bridging interfaces (IRBs).

Each vlan may be associated with a IP subnet entry (the terms vlan and subnet may be used interchangeably throughout this specification). Vlans typically span across multiple ToRs so that it is possible to effectively utilize the resources on different PODs dynamically as a function of demand. Generally, ToRs have relatively smaller MAC tables (for bridging) and FIB/Adjacency tables (for routing) given the drive for lower cost ToRs. However, the data center is still expected to scale to millions of hosts/servers with any-to-any communication being the prime requirement. There exists a need to achieve this level of massive scaling even with smaller ToR table sizes.

### BRIEF DESCRIPTION OF THE DRAWINGS

The accompanying drawings, which are incorporated in and constitute a part of this disclosure, illustrate various embodiments. In the drawings:

FIG. 1 illustrates an example network environment for embodiments of this disclosure;

FIG. 2 illustrates an example network environment for embodiments of this disclosure;

FIG. 3 is a flow chart illustrating embodiments of this disclosure;

FIG. 4 is a flow chart illustrating embodiments of this disclosure; and

FIG. 5 is a block diagram of a computing network device.

### DESCRIPTION OF EXAMPLE EMBODIMENTS

### Overview

Consistent with embodiments of the present disclosure, systems and methods are disclosed for scaling a massive data center by representing SVIs as special internal port-channels that are facilitated by the switch fabric.

It is to be understood that both the foregoing general description and the following detailed description are examples and explanatory only, and should not be considered to restrict the application's scope, as described and claimed. Further, features and/or variations may be provided in addition to those set forth herein. For example, embodiments of the present disclosure may be directed to various feature combinations and sub-combinations described in the detailed description.

### DETAILED DESCRIPTION

The following detailed description refers to the accompanying drawings. Wherever possible, the same reference numbers are used in the drawings and the following description to refer to the same or similar elements. While embodiments of this disclosure may be described, modifications, adaptations, and other implementations are possible. For example, substitutions, additions, or modifications may be made to the elements illustrated in the drawings, and substituting, reordering, or adding stages to the disclosed methods may modify the methods described herein. Accordingly, the following detailed description does not limit the disclosure. Instead, the proper scope of the disclosure is defined by the appended claims.

In order to improve IP scalability in distributed platforms like in a large data center, pending U.S. patent application Ser. No. 13/422,155 which is incorporated in its entirety herein, suggests employing ARP enhancements to implement a conversational IP based scheme. There, ToRs will only install entries in the FIB for directly connected servers that are currently part of a conversation or an active flow from at least one server in the associated POD. The problem with this approach is that it requires changes to the ARP protocol, is fairly complicated in terms of its implementation and requires sophisticated schemes to determine when to remove entries for inactive conversations as well as what candidates to evict to install newer entries in case the FIB tables approach their capacity.

Pending U.S. patent application Ser. No. 13/490,831 which is incorporated in its entirety herein, proposes to solve the scaling problem by employing an ECMP-based solution. Specifically, ToR membership for an SVI is tracked by software and any changes in the membership require the ECMP group to be updated in the corresponding FIB/Adjacency entry associated with the SVI. The disadvantages of this solution are that as the ECMP group membership increases, more adjacency entries will be utilized; consequently there is a dependence on the size of the adjacency/next-hop tables of the ToR. Moreover, ToR membership change for a given vlan/SVI requires reprogramming of the corresponding subnet entry associated adjacencies. Embodiments of the present disclosure are designed to avoid the problems of prior implementations.

Port channels may allow traffic to be naturally load-balanced over its members based on the hash-selection. A fabric port-channel is a special “internal” port-channel that may allow traffic to be load balanced over its member links. Specifically, when a SVI is represented by a fabric port-channel, this will comprise the set of all ToRs that have at least one port in the corresponding vlan. Member ToRs may be added or deleted from the set of a given SVI based on configuration events.

Each internal port-channel may be represented by a unique index (also called a destination-index). When the switch fabric sees a packet directed to an index, (the directing may be based on a hash), it directs the packet to the selected ToR from the set of all ToRs associated with the SVI. The hash may be based on the fields of the packet such as SMAC, DMAC, SIP, DIP, Protocol etc. The hash value itself can be generated by the forwarding-engine in an ingress ToR and carried with the packet. In some embodiments of the present disclosure, the hash value may be generated by the switch-fabric whenever it sees a packet directed toward an internal fabric port-channel. For a given flow, the same hash value may be generated so that the same ToR is selected throughout the flow. Consequently, there are no packet out-of-order issues.

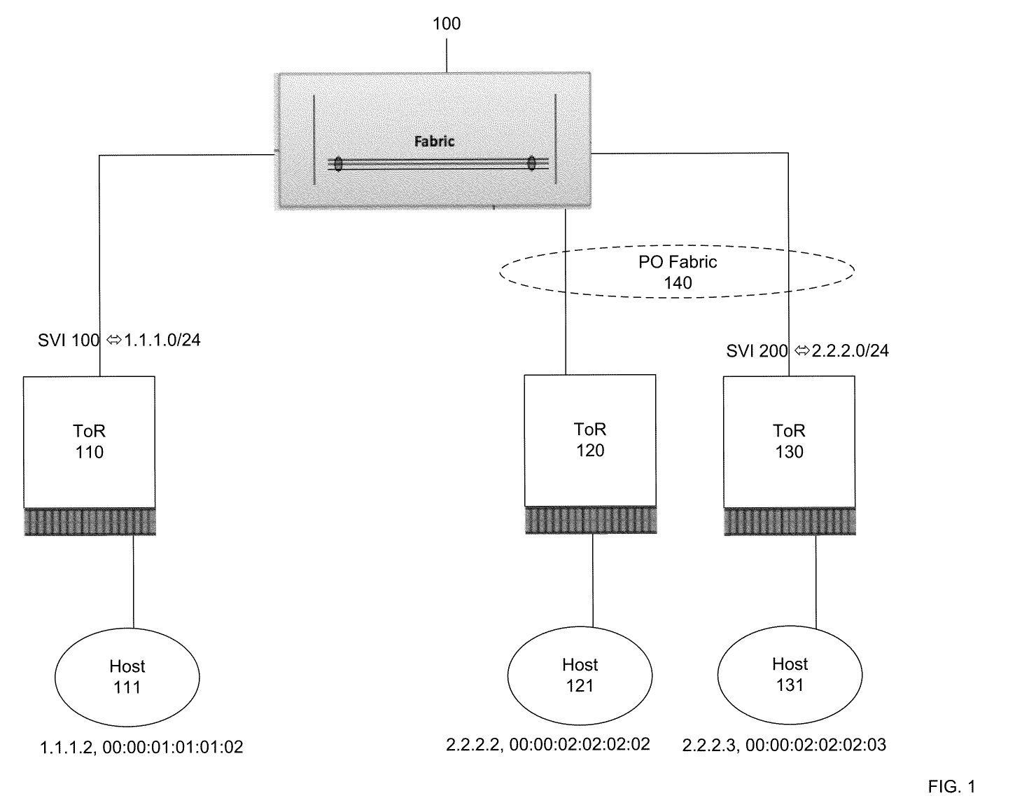

FIG. 1 illustrates an example network environment for embodiments of this disclosure. FIG. 1 shows a sample configuration where a spine 100 is attached to ToR 110, ToR 120, and ToR 130. Hosts, such as host 111, host 121, and host 131, respectively are directly attached to ToR 110, ToR 120, and ToR 130. In this example, for illustration purposes, two subnets exist, where host 111 belongs to subnet 1.1.1.0/24. Host 121 and host 131 belong to subnet 2.2.2.0/24.

When host 111 wants to communicate with either host 121 or host 131, ToR 110 may be programmed so that it will drive the packet to the fabric 100 with a destination index corresponding to port-channel 140 which in turn maps to subnet 2.2.2.0/24 or vlan 200. This port-channel has special meaning within the fabric in that it has two members ToR 120 and ToR 130. Based on the hash, the packet will be directed to either ToR 120 and ToR 130 where the final rewrite will occur.

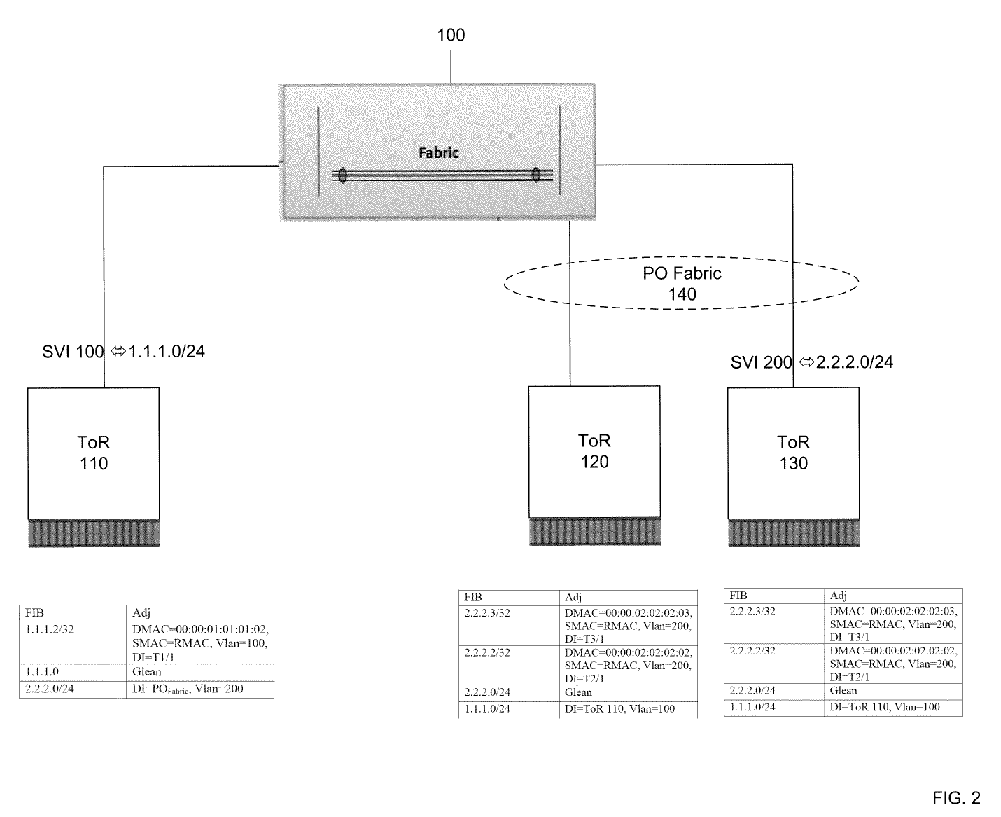

FIG. 2 shows the relevant forwarding hardware table programming on ToR 110, ToR 120, and ToR 130, the details of how this is done are described below.

For a given vlan, a “local” ToR refers to a ToR that has at least one port in that vlan else it is called a “non-local” ToR. Non-local ToRs may install only a single subnet entry corresponding to a remote SVI/vlan in their FIB. This is repeated for all the remote vlans/SVIs. Only the local ToRs install the server address entries corresponding to the hosts in the local vlans in their FIB.

Every vlan is associated with a subnet. Whenever an SVI is configured, software may request allocation of an internal fabric port-channel for the SVI. Software keeps track of ToR membership for a given vlan (and corresponding SVI). The membership information may be programmed in the fabric hardware tables (typically FPOE table, port-channel membership table, etc.) to track the membership associated with the fabric port-channel.

Assume that servers in different vlans want to communicate with one another. Whenever a packet is received on an input switch-port of a ToR with a certain vlan membership and is subsequently directed to a host/server in a different vlan for which this ToR is non-local, the subnet entry in the FIB will be hit. The corresponding adjacency entry will provide the destination-index. In this case, it will be programmed with the destination index associated with the internal fabric port-channel that represents the egress SVI interface. No MAC rewrites are performed on the packet before it is dispatched to the candidate ToR.

When the switch-fabric 100 receives the packet with this destination-index, based on the generated hash, it will direct the packet to one of the candidate set of local ToRs. Again, a local ToR is one that has at least one port member in that vlan reachable on the first hop.

Once the packet reaches the candidate ToR, a lookup for the destination server may be performed. In a first case, the ARP entry for this destination has been resolved. In that case, the IP address entry for this destination will be installed in the FIB table of this ToR. The corresponding next-hop entry will indicate the rewrites to be applied to the packet in terms of SMAC, DMAC, TTL-decrement etc. Now the final port of exit to reach this destination may be either local or remote (i.e. via another ToR). In case of the former, the rewritten packet is just sent out of the local port. In case of the latter, the rewritten packet will be sent to the correct ToR that has the destination as its directly-connected-host (DCH).

In the case where the ARP entry for this destination has not been resolved, the IP entry is not present, then the glean subnet entry will be hit in the FIB table. This will trigger an ARP request to retrieve the MAC address of the corresponding destination IP address. Once the ARP response is obtained, the IP address entries will be installed in all of the local ToRs for this vlan.

Once the IP address is installed, the remainder follows as described above when the ARP entry for this destination has been resolved. So in summary, any server can reach any other server via a maximum of two hops. The first hop is a routing-hop while the second hop where the rewritten packet is directed to target ToR is a bridging-hop. In this way, all candidate/local ToRs share the “burden” of hosts in a vlan; this is transparently provided by switch-fabric 100.

Software does not need to reprogram the adjacency entries in the non-local ToRs if one of the local ToRs leaves or enters membership of a certain vlan. Only switch-fabric 100 needs to update the membership associated with the fabric port-channel associated with the vlan/SVI. This feature helps provide embodiments of the present disclosure inbuilt fault tolerance. A given ToR going down will only affect the hosts that are directly connected to that ToR and not the traffic for other hosts for which this ToR served as an intermediate hop. Such a scheme is especially useful in scenarios where a POD needs to be decommissioned or migrated. In that case, the fabric port-channel membership can be rapidly updated yielding minimal traffic loss.

In some embodiments of the present disclosure, the index that represents the destination vlan associated fabric port-channel is carried in the packet as part of the header. In fact, the index can be encoded in a standard TRILL header as well in the destination RBridgeID field.

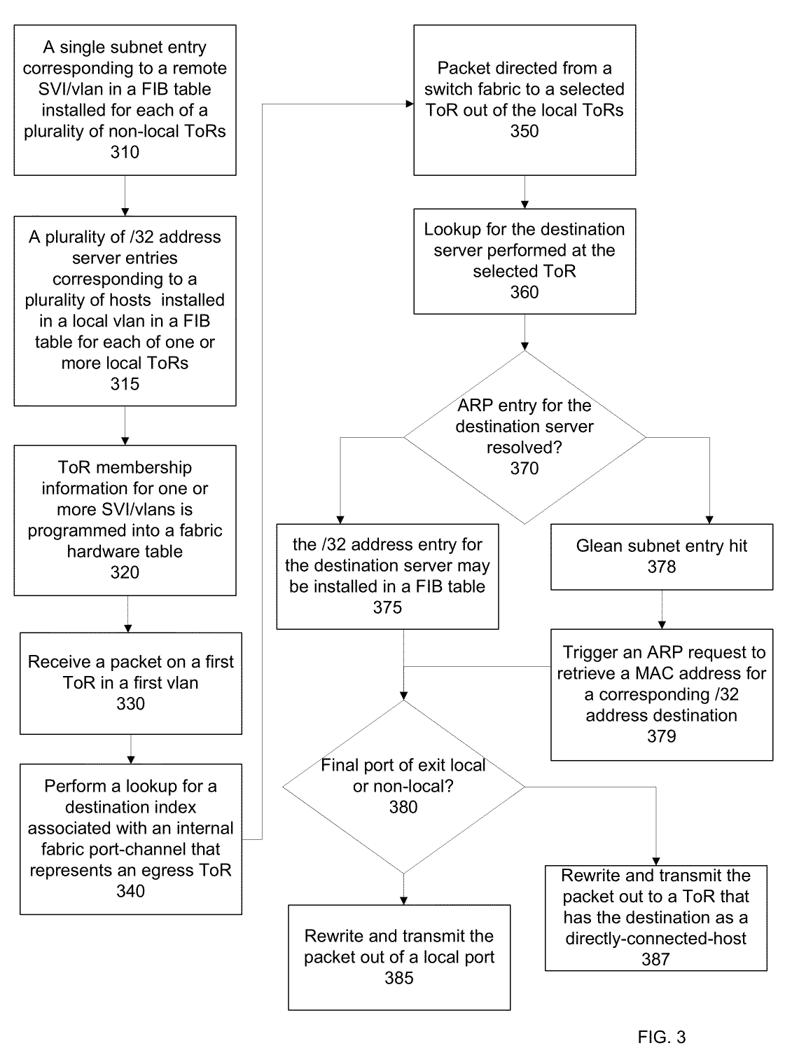

FIG. 3 is a flow chart illustrating embodiments of the present disclosure. Method 300 may begin at step 310 where a single subnet entry corresponding to a remote SVI/vlan in a FIB table may be installed for each of a plurality of non-local ToRs. Similarly, at step 315, a plurality of server IP address entries corresponding to a plurality of hosts may be installed in a local vlan in a FIB table for each of one or more local ToRs.

Method 300 may then proceed to step 320. At step 320, ToR membership information for one or more SVI/vlans may be programmed into a fabric hardware table. In some embodiments, the ToR membership information may comprise a set of candidate next-hops to be installed on all non-local ToRs whose FIB entry has a subnet entry for the vlan associated with the ToR. After the determination of membership information, method 300 may then proceed to step 330 and receive a packet on a first ToR in a first vlan. In the present example, the packet is directed to a host in a second vlan for which the first ToR is non-local. FIB lookup on destination host address will direct the packet toward the switch-fabric with the destination index representing the egress SVI associated fabric port-channel.

Method 300 may proceed to step 340 and perform a lookup for a destination index. Upon resolution of the destination index to a particular member egress ToR, method 300 may proceed to step 350. At step 350, the packet may be directed from a switch fabric to a selected ToR out. In some embodiments, selection of the selected ToR out of the local ToRs is the result of a generated hash function.

Next, method 300 may proceed to step 360. At step 360, a lookup for the destination server may be performed at the selected ToR. Subsequently at step 370 it may be determined whether an ARP entry for the destination server has been resolved.

If the ARP entry has been resolved, the host address entry for the destination server may be installed in a FIB table at step 375. If the ARP entry has not been resolved a glean subnet entry may be hit at step 378.

From step 378, method 300 may proceed to step 379 and trigger an ARP request to retrieve a MAC address for a corresponding host IP address destination. Next, at step 379 where the corresponding destination IP address is installed on all local ToRs.

Method 300 may then proceed from either step 379 or 375 to step 380. At step 380 it may be determined whether a final port of exit is local or non-local. If the final port of exit is determined to be local, method 300 proceeds to step 385 and rewrites and transmits the packet out of a local port.

If the final port of exit is determined to be non-local, method 300 proceeds to step 387 and rewrites and transmits the packet out to a ToR that has the destination as a directly-connected-host.

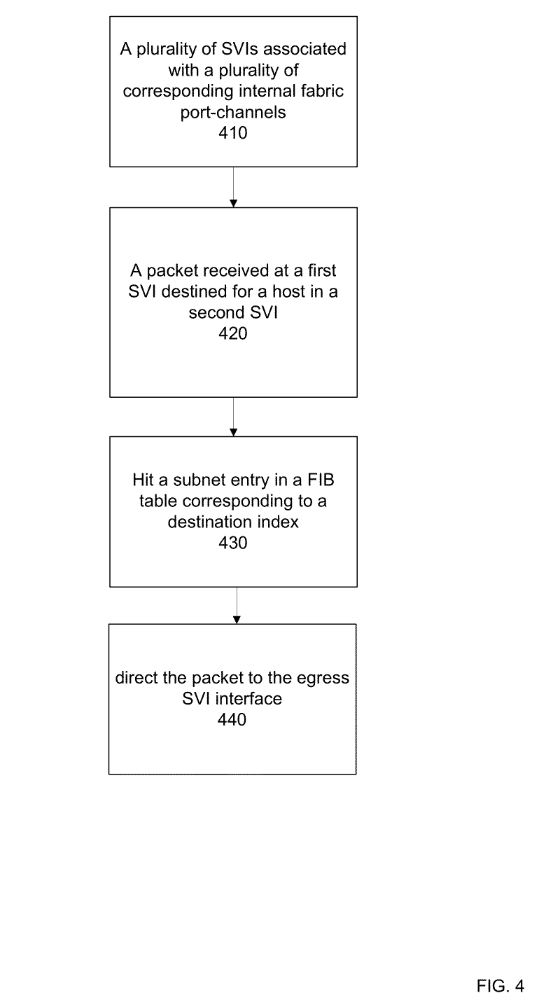

FIG. 4 is a flow chart illustrating embodiments of the present disclosure. Method 400 may begin at step 410 where a plurality of SVIs are associated with a plurality of corresponding internal fabric port-channels. At step 420 a packet may be received at a first SVI destined for a host in a second SVI.

After the packet is received, method 400 may proceed to step 430. At step 430, a subnet entry in a FIB table corresponding to a destination index may be hit. In some embodiments, the destination index may be associated with an internal fabric port-channel that represents an egress SVI interface. Method 400 may then proceed to step 440 and direct the packet to the egress SVI interface.

As described herein, embodiments of the present disclosure allow for improved IPv4/IPv6 scalability in data centers where each ToR still has relatively small L3 FIB table and L2/MAC table sizes. It may be ensured that every server can communicate with every other server via a maximum of 2-hops. Furthermore, when ToR membership for a given vlan changes, the FIB/Adjacency entries for the other ToRs do not need to change since they point to the internal port-channel destination-index. All the membership changes are absorbed in the switch-fabric that takes care of updating the port-channel membership.

Embodiments of the present disclosure further provide inbuilt fault-tolerance in that when a certain ToR goes down the effects of the failure are localized. Only the servers in that POD become unreachable while the rest of the network is relatively unaffected. Moreover, no reprogramming of the adjacency entries is needed for the non-local ToRs.

Since the SVI is represented by an internal fabric port-channel, the hash generation can be shifted into the switch fabric. Consequently, this removes the burden from the ToR and potentially avoids traffic polarization issues. Also the complete setup and update of the fabric port-channel may be driven by configuration events as opposed to dynamic protocol event updates. This allows for simple software implementation of embodiments.

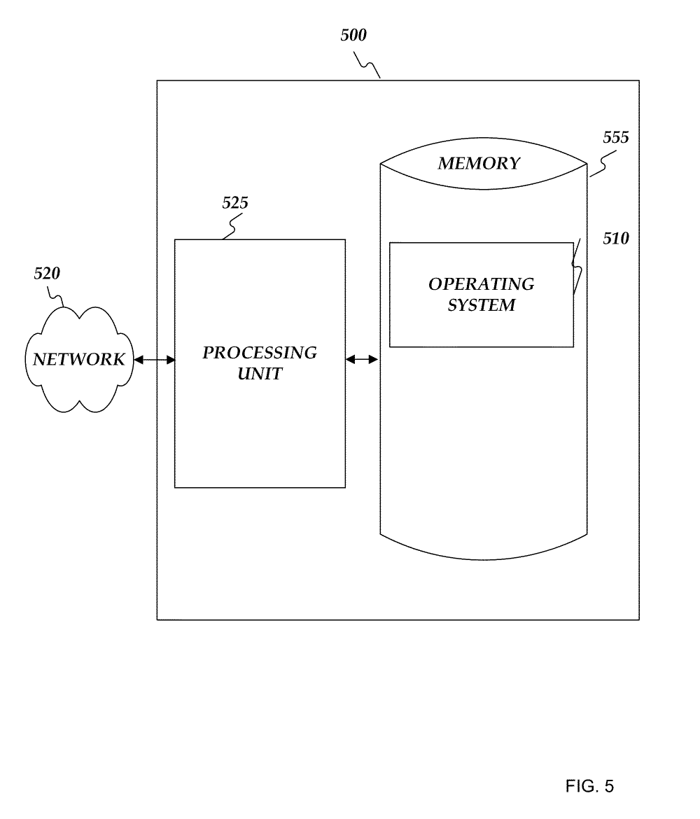

FIG. 5 illustrates a computing device 500, such as a server, host, or other network devices described in the present specification. Computing device 500 may include processing unit 525 and memory 555. Memory 555 may include software configured to execute application modules such as an operating system 510. Computing device 500 may execute, for example, one or more stages included in the methods as described above. Moreover, any one or more of the stages included in the above describe methods may be performed on any element shown in FIG. 5.

Computing device 500 may be implemented using a personal computer, a network computer, a mainframe, a computing appliance, or other similar microcomputer-based workstation. The processor may comprise any computer operating environment, such as hand-held devices, multiprocessor systems, microprocessor-based or programmable sender electronic devices, minicomputers, mainframe computers, and the like. The processor may also be practiced in distributed computing environments where tasks are performed by remote processing devices. Furthermore, the processor may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, a wireless fidelity (Wi-Fi) access point, or a facsimile machine. The aforementioned systems and devices are examples and the processor may comprise other systems or devices.

Embodiments of the present disclosure, for example, are described above with reference to block diagrams and/or operational illustrations of methods, systems, and computer program products according to embodiments of this disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and are the property of the Applicant. The Applicant retains and reserves all rights in the code included herein, and grants permission to reproduce the material only in connection with reproduction of the granted patent and for no other purpose.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

What is claimed is:

1. A method for IP scaling comprising:
installing a single subnet entry corresponding to a remote SVI/vlan in a FIB table for each of a plurality of non-local ToRs;
installing a plurality of server IP address entries corresponding to a plurality of hosts in a local vlan in a FIB table for each of one or more local ToRs;
programming ToR membership information for one or more SVI/vlans into a fabric hardware table;
receiving a packet on a first ToR in a first vlan, wherein the packet is directed to a host in a second vlan for which the first ToR is non-local;
performing a lookup for a destination index associated with an internal fabric port-channel that represents an egress ToR;
directing the packet from a switch fabric to a selected ToR out of the local ToRs;
performing a lookup for the destination server at the selected ToR;
determining whether an ARP entry for the destination server has been resolved; and
installing the destination server IP address entry in a FIB table if the ARP entry has been resolved.

2. The method of claim 1, wherein selection of the selected ToR out of the local ToRs is the result of a generated hash function.

3. The method of claim 1, wherein ToR membership information comprises a set of candidate next-hops to be installed on all non-local ToRs whose FIB entry has a subnet entry for the vlan associated with the ToR.

4. The method of claim 1, further comprising determining whether a final port of exit is local or non-local.

5. The method of claim 4, further comprising rewriting and transmitting the packet out of a local port if the final port of exit is determined to be local.

6. The method of claim 1, further comprising:
hitting a glean subnet prefix entry if the ARP entry has not been resolved;
triggering an ARP request to retrieve a MAC address for a corresponding destination IP address; and
installing the corresponding destination IP address on all local ToRs.

7. The method of claim 4, further comprising rewriting and transmitting the packet out to a ToR that has the destination as a directly-connected-host if the final port of exit is determined to be non-local.

8. The method of claim 1 further comprising:
detecting that a ToR leaves or enters membership of a certain vlan; and
updating the fabric hardware table with updated membership information.

9. A method for IPv4 scaling comprising:
representing a plurality of SVIs with a plurality of corresponding internal fabric port-channels;
receiving a packet at a first SVI destined for a host in a second SVI;
hitting a subnet entry in a FIB table corresponding to a destination index, wherein the destination index is associated with an internal fabric port-channel that represents an egress SVI interface; and
directing the packet to the egress SVI interface.

10. The method of claim 9, further comprising:
generating a hash function for selection of candidate ToRs at the switch fabric.

11. The method of claim 10, further comprising employing the generated hash function to select one of the candidate ToRs.

12. The method of claim 11, wherein generated hash function is based at least in part on a SMAC field contained in the packet.

13. The method of claim 9 wherein the subnet entry indicates rewrites to be made to the packet.

14. The method of claim 13, further comprising:
triggering an ARP request to retrieve a MAC address for a corresponding destination IP address; and
installing the corresponding destination IP address on all local ToRs.

15. The method of claim 13, further comprising:
determining whether the egress SVI interface is local or non-local.

16. A method comprising:
representing each of a plurality of internal port channels by a unique index;
detecting a packet directed to a first unique index; and
selecting a first ToR out of one or more candidate ToRs associated with a first SVI, wherein the SVI is identified by the first unique index.

17. The method of claim 16, further comprising:
generating a hash function for use in the selection of the first ToR, wherein the hash function is based on one or more fields within a received packet.

18. The method of claim 17, wherein the hash function is generated at a forwarding engine.

19. The method of claim 18, further comprising adding the hash function to the received packet.

20. The method of claim 17, further comprising generating the hash function at a switch fabric upon detecting the packet heading to a first internal port channel.
